(19) United States
(12) Patent Application Publication
(10) Pub. No.: US 2009/0111405 A1
(43) Pub. Date: Apr. 30, 2009

(54) Signal matching module for single or multiple systems

(76) Inventors: Chung-Er Huang, Taipei (TW); Huang-Chan Chien, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/976,938

(22) Filed: Oct. 30, 2007

(51) Int. Cl. H04B 3/46; H01P 5/12; H04B 1/16

(52) U.S. Cl. 455/150.1; 333/101; 375/224

(57) ABSTRACT

A signal matching module for single or multiple systems is disclosed, thereby enhancing the flexibility in using a communication module, and the performance of each subsystem. Further, a fine-tuning function is introduced into a selective matching circuit for the case that the inner matching components in the communication module cannot reach a required matching. Still further, a multi-stage matching circuit is used to reach a required Q-value (quality factor) for the matching circuit, thereby tuning the bandwidth. One of the preferred embodiments is to provide a unit cell which is used to connect with one or multiple subsystems, and a feeding point disposed outside the matching circuit to generate a better impedance matching and bandwidth.

### BACKGROUND OF THE INVENTION

1. Field of the Invention

The present invention discloses a signal matching module for single or multiple systems, more particularly to dispose the signal matching module in the module of the signal or multiple systems, so as to reach a required matching without performance loss.

2. Description of Related Art

In the field of wireless communication, interference amid noise signals and circuits in high-frequency communication often occurs and further affects the performance of wireless communication. Especially if a communication module couples to multiple systems, such as WiFi, Bluetooth, GSM, WiMAX (Worldwide Interoperability for Microwave Access) and the like, many unpredictable interferences may be generated.

For example, in a wireless communication device with a high-frequency module and several wireless communication networks installed, such as Bluetooth, GSM and WiMAX, a switch or a circulator is usually used for switching the transmitted or received signal.

An exemplary embodiment relating to the mentioned circulator is such as a the circulator used for a high-frequency amplifier disclosed in U.S. Pat. No. 6,894,562 which is issued on May 17, 2005. In which, a divider divides an input high-frequency signal into two output signals, and the circulator adjusts an effect for amplifying the signal. Reference is made to FIG. 1, a high-frequency signal is fed into an input terminal 1, and outputted from a output terminal 2. A divider 3 divides the high-frequency signal fed from the input terminal 1 into two signaling directions, wherein one direction passes through a primary amplifier 4, and another one direction passes through a secondary amplifier 5. A circulator 6 is provided to transfer the high-frequency signal from the secondary amplifier 5 to the output terminal of the primary amplifier 4, such as the dotted line shown in the diagram. The high-frequency signal outputted from the primary amplifier 5 is transferred to the output terminal 2, such as the solid line shown in the diagram. Therefore, the circulator is used to generate variant effects on amplifying.

In a related technology regarding to a module having multiple wireless communication subsystems, the mentioned switch is often used to switch the communication signals among the variant subsystems. FIG. 2 shows a schematic diagram of the mentioned communication module of the subsystem. The communication device includes a first communication module 25 and a second communication module 26. The first communication module 25 utilizes a bidirectional transmission line to perform the signal reception and transmission (RX/TX). The second communication module 26 utilizes a transmission line for signal reception (RX) and another transmission line for signal transmission (TX). Both the communication modules use a coupler 22 to couple with the transmission lines of the first communication module 25 and the second communication module 26, thereby to insulate the other signals and allocate the direction for each signal. After that, the switch 20 switches the signal allocated by the coupler 22 and the transmission signal of the second communication module 26, and then sent to the antenna 21 for signal reception and transmission.

Reference is made to the exemplary embodiment shown in FIG. 2. The first communication module 25 can be implemented as a Bluetooth module that features a bidirectional transmission line for transmitting and receiving signals. The second communication module 26 can be a wireless network (WiFi) module that features a transmission line for respectively transmitting and receiving signals. The switch 20 is used for switching the signals received from the antenna 21 to each communication module based on the types therefor. Further, the coupler 22 is used to guide the signals to each communication module. And vice versa, the signals sent transmitted from each communication module are transmitted via the coupler 22, switch 20 and the antenna 21.

With the development of the technologies, many wireless communication systems can be installed in one module—including the mentioned wireless communication network, Bluetooth, GSM and WiMAX. In view of in this module having multiple subsystems, one system probably interferes with the other system when those subsystems operate at the same time. Especially under consideration of capacity and cost, probably only one common port configured to an I/O port for each subsystem is installed. Therefore, the performance of communication could drop if there is no special design for the communication module.

### SUMMARY OF THE INVENTION

According to the foregoing shortcomings of a conventional communication module used for the subsystem, one common port adopted for the system will produce interference among the subsystems and affect the performance of communication. However, the present invention provides a signal matching module for single or multiple systems, which implements a flexible use of the communication module by means of a multiple or single I/O port without any change to the conventional communication module components and circuits.

Additionally, the signal matching module for single or multiple systems provides an optional matching circuit. An external circuit can be used to fine tune the module when the inner matching component of the module fails to reach a required matching impedance. The optional matching circuit can utilize a means for multiple matching to achieve a required quality factor (Q-value) when the inner matching component can be tuned to a required impedance. Thus, the bandwidth of the matching is tunable.

The preferred embodiment of the single or multiple systems of the present invention functions as a communication module for single or multiple subsystems. The system includes a unit cell is included connecting with the single or multiple subsystems, and the unit cell has a plurality of interconnected electronic components or transmission lines. Further, one or a plurality of communication ports inside the signal matching module of the single or multiple systems are connected with the external signals, and provide tuning interfaces for the inner circuits of the signal matching module. Therefore no extra loading is received by the inner circuit of the signal matching module by the connected devices, and direct interference or signal loss can be avoided.

In the other embodiment of the present invention, a multi-order matching is realized by combining the mentioned plurality of unit cells, so as to reach a required quality factor (Q-value) and bandwidth.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 shows a schematic diagram of a circular for the prior art;

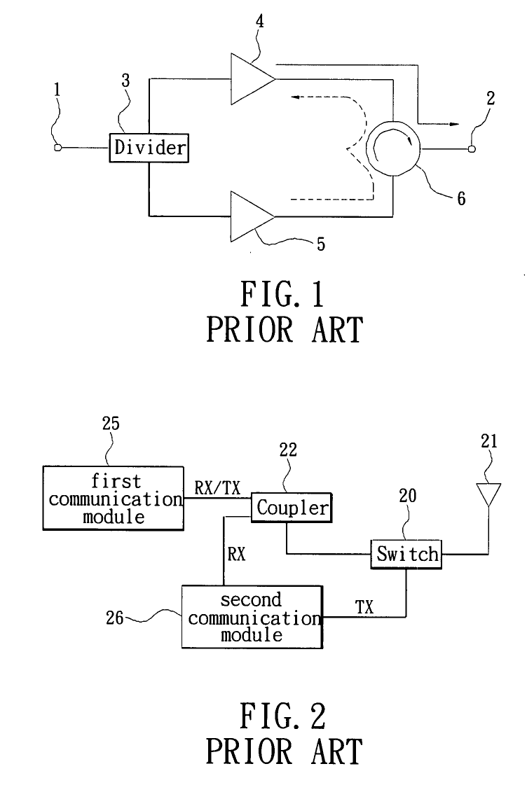

FIG. 2 shows a schematic diagram of the multiple subsystems of the prior art;

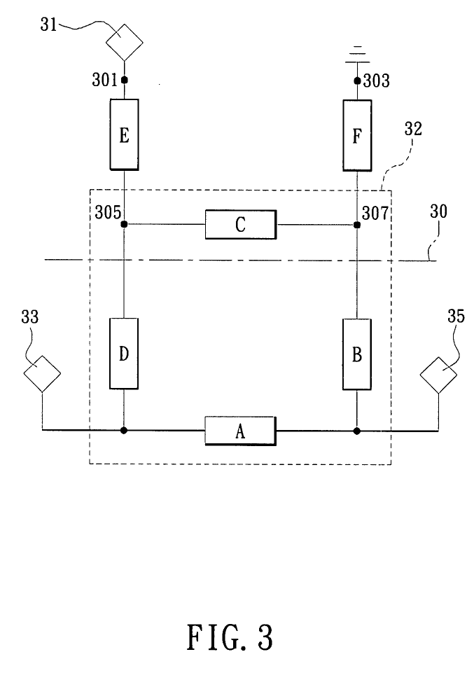

FIG. 3 shows a schematic diagram of a unit cell of signal matching module for the single or multiple systems of the present invention;

FIG. 4A and FIG. 4B shows a schematic diagram of the unit cell of the signal matching module of the present invention;

FIG. 5A and FIG. 5B are the chart showing curves between the frequencies and insertion losses for the unit cell that connects with two subsystems;

FIG. 6A and FIG. 6B show the schematic diagram of the unit cell of the signal matching module of the present invention;

FIG. 7A and FIG. 7B are charts showing the curve between the frequencies and losses for the unit cell that connects with two subsystems;

FIG. 8 shows a Smith Chart for a multi-order matching;

FIG. 9A through FIG. 9C are charts showing a curve between the frequencies and insertion losses provided by the present invention;

FIG. 10 shows a schematic diagram of the signal matching module of the embodiment of the present invention.

### DETAILED DESCRIPTION OF THE PREFERRED EMBODIMENTS

The present invention is illustrated with a preferred embodiment and attached drawings. However, the invention is not intended to be limited thereby.

The present invention provides a signal matching module for single or multiple systems for a communication module of single or multiple subsystems rather than a common communication port, thus solving the problem of the interference among the subsystems. A selective matching circuit is provided for the signal matching module, thereby to tune an inner matching component to reach a required matching impedance. Moreover, if the inner component of the signal matching module reaches the required matching impedance, the selective matching circuit uses a multi-order matching to achieve the required quality factor (Q-value) for tuning the bandwidth therefor.

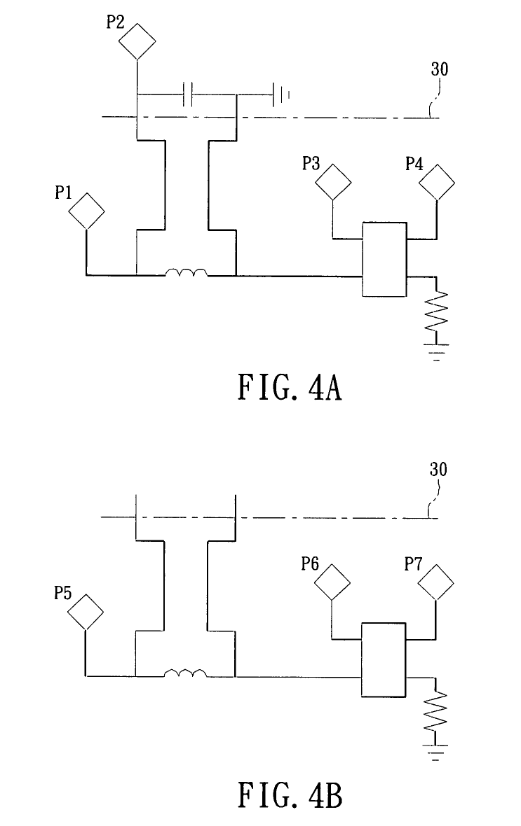

Reference is made to FIG. 3, which shows a schematic diagram of a unit cell in the signal matching module of the preferred embodiment. The unit cell is used to connect to multiple subsystems, or to one subsystem in another embodiment. The unit cell is implemented as an interface apparatus connecting with each subsystem. The unit cell 32 electrically connects to an internal communication port of one or a plurality of signal matching module, or to an external communication port thereof. This exemplary embodiment shows one external communication port of the signal matching module. Further, each communication port electrically connects to the unit cell. The communication port connecting with the external signaling source embodies one or a plurality of external feeding point of the module. The unit cell 32 at least includes the interconnected electronic components or transmission lines, and connects to the external signaling source through the external communication port installed outside the signal matching module. For example, the external signaling source can be a device that produces communication signals. The unit cell 32 also provides a tuning interface for the inner circuit. Therefore, no extra loading will be received by the inner circuit from the signaling source, and the direct interference or signal loss can be avoided.

Such as the embodiment shown in the diagram, the unit cell 32 at least includes a first component A, second component B, third component C, and fourth component D. Each block shown in the diagram, including the first component A, the second component B, the third component C, the fourth component D, a fifth component E and a sixth component F, can be a general passive component such as a circuitry having resistor, capacitor and inductor, and also can be a transmission line. In the diagram, at least one connecting terminal (301, 303, 305, 307) used to connect with other module, circuit or ground is mounted above a reference plane 30 presented by dotted line. Those connecting terminals 301, 303, 305 and 307 can connect to another communication port, circuit, module or ground.

Further, a communication port 31 for each subsystem is mounted above the reference plane 30. The communication port 31 electrically connects to the unit cell 32 that forms one or more external feeding points of the signal matching module. Thereby the unit cell 32 can process tuning externally, and no extra loading is produced for the inner circuitry. Further, the inner matching component can be fine tuned and easily reach the required matching. In addition, two other communication ports 33, 35 are mounted below the reference plane 30, thereby to connect the communication module disposed inside the other device.

The combination of the plurality of unit cell 32 in another embodiment form a multi-order matching circuit. The multi-order signal matching is tuned to achieve the object of the present invention, that is to reach the required quality factor (Q-value), and then the bandwidth can be tuned by the matching.

The signal matching module for the multiple systems shown in FIG. 3 is a preferred embodiment of the present invention. In particular, the communication port 31 that connects to the external communication module can process the tuning externally, and it won't cause the loss, interference or other influence of the inner circuitry.

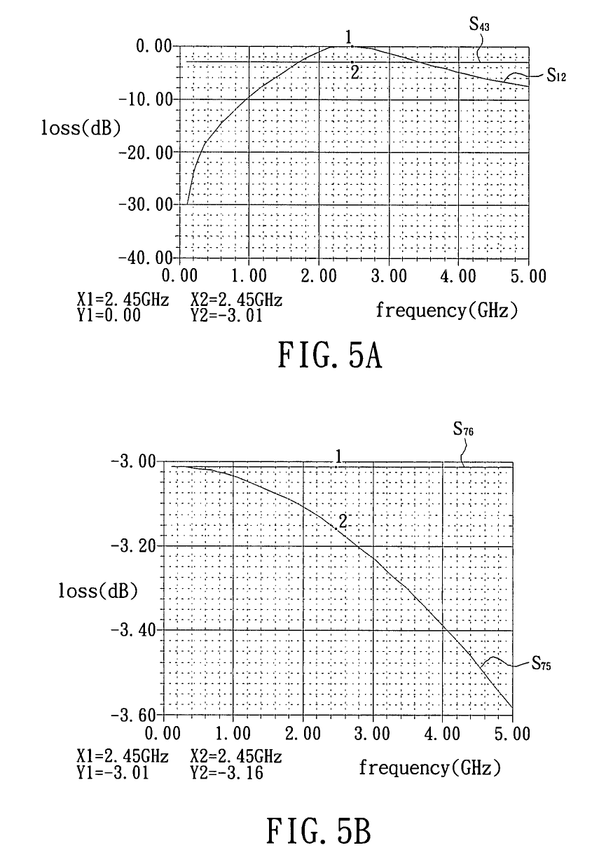

Next, FIG. 4A and FIG. 4B show a schematic diagram of a unit cell of the signal matching module for the single or multiple systems of the present invention. Such as the embodiment shown in FIG. 4A describing a unit cell without any external communication port installed, a horizontal dotted line presents a reference plane 30, and the inner components of the signal matching circuit are disposed underneath the reference plane 30. In particular, a first port P1, third port P3 and fourth port P4 therein are used to connect with other modules. For example, the ports connect with variant subsystems, especially to the wireless communication systems—including WiFi, Bluetooth, GSM, UWB (Ultra Wide Band), DVB (Digital Video Broadcasting), GPS, 3G and WiMAX. Moreover, a second port P2 is disposed above the reference plane 30 for connecting with other circuit or module. FIG. 4B shows a schematic diagram of another unit cell. The unit cell has a fifth port P5, sixth port P6 and seventh port P7 which are disposed underneath the reference plane 30.

The mentioned reference plane 30 is to distinguish the inner circuit and outer circuit of the signal matching module. In an embodiment of the communication system, a feeding point is disposed outside the module, such as the second port P2 shown in FIG. 4A, and a selective matching circuit is electrically connected. If the inner matching component in the module fails to reach a required matching, the signal matching module can be tested and tuned externally through the feeding point, so that the loss, interference or other influences can be avoided. Even though the inner component of the module reaches the required matching, the selective matching circuit adopts a multi-order matching to reach the required quality factor (Q-value), thereby to be tuned to the required bandwidth.

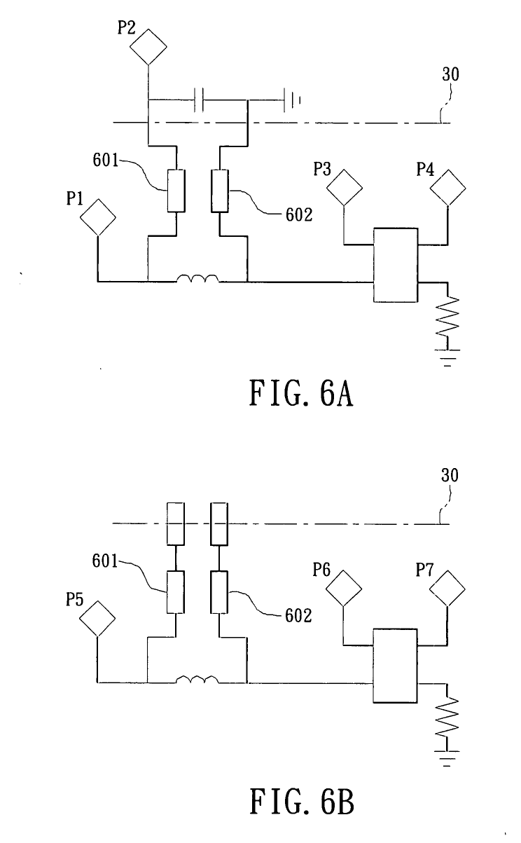

According to the exemplary embodiment of FIG. 4A, the first port P1, third port P3 and fourth port P4 of the inner circuit, and the second port P2 outside the module are included. Next, FIG. 5 shows a chart having a curve presenting the relation between insertion loss and frequency as the signals are transmitted among the ports in an ideal circuit. In which, a default insertion loss of the inner circuit is set −3 dB. The chart shown in FIG. 5 presents a curve of S-parameter that is a basic measurement tool in the process of RF design, thereby to simulate the behavior of an electronic component under different frequencies.

The curve S₄₃ presents the insertion loss of the signal emitted from the third port P3 and received via the fourth port P4 in a subsystem. Since the third port P3 and the fourth port P4 are the communication ports that are disposed internally, the insertion loss is about −3.01 dB, the default value. That is at the frequency 2.45 GHz that is the experiment of the present invention concerns.

The curve S₁₂ presents the insertion loss of the signal emitted from the second port P2 outside the circuit, and received through the first port P1 disposed inside the circuit in another subsystem. Obviously, the insertion loss at point 1 of curve S₁₂ that presents frequency 2.45 GHz is better than the insertion loss for curve S₄₃. Ideally, the insertion loss at point 1 is 0.00 dB. Therefore, the signal matching module for the single or multiple systems of the present invention has better performance because there is a matching circuit disposed outside the module that won't cause loss on the inner circuit.

According to the embodiment shown in FIG. 4B, FIG. 5B shows a curve presenting the relation between the insertion loss and frequency as signaling among the ports in an ideal circuit. In which, a default loss for the inner circuit is set −3 dB.

The curve S₇₆ presents the insertion loss of the signal emitted from the sixth port P6 disposed inside the circuit, and received through the seventh port P7 in a subsystem. Since the default loss for the inner circuit is set about −3 dB, the insertion loss has no much change at the point 1 presenting −3.01 dB under frequency 2.4 GHz.

The curve S₇₅ presents the insertion loss of the signal emitted from the fifth port P5 and received via the seventh port P7 in another subsystem. Since there is more complex influence from the circuit between the two ports, a larger insertion loss is produced. But the loss is still around the default loss at point 2 presenting −3.16 dB under frequency 2.4 GHz.

In proof of the above-mentioned experiment in FIG. 4A, the external signal feeding point can be used to achieve the lowest insertion loss without any change of the inner circuit of the signal matching module, ideally the insertion loss is zero. More, a resonance effect can be used to function the similar filtering means. In an exemplary embodiment of the dual-subsystem module shown in FIG. 4B, there is no difference between their characteristics. That is, the insertion loss at each feeding point has no too much difference.

Therefore, the selective matching circuit provided by the signal matching module of the present invention can reduce insertion loss and prevent the interference caused by the inner circuit. More, the present invention can reduce the interference occurred among the subsystems if it is applied to the multiple subsystems.

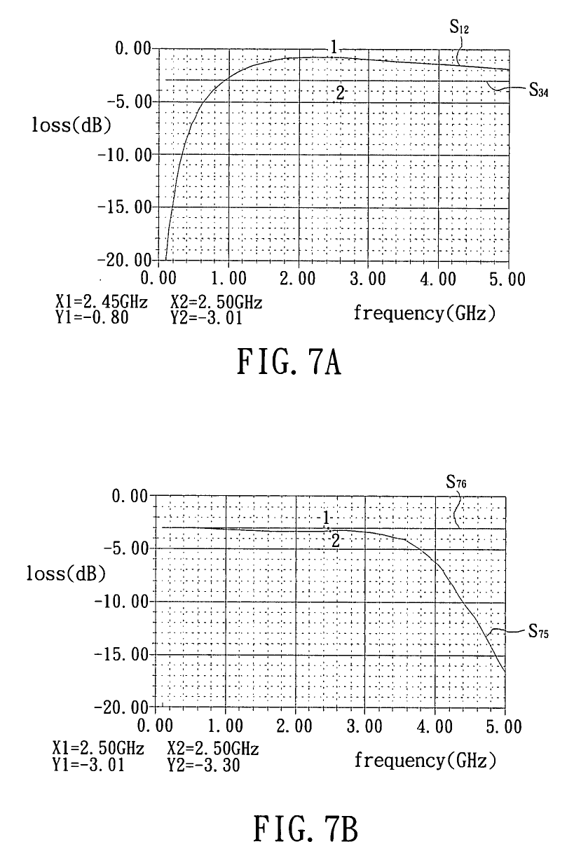

FIG. 6A and FIG. 6B show a block diagram of the signal matching module with a transmission line effect for the single or multiple systems. The FR4 stripline transmission line with dielectric coefficient 4.4 is under consideration in the exemplary embodiment, and also considering the coupling effect and dielectric loss among the transmission lines.

In the embodiment of the unit cell shown in FIG. 6A, an external communication port above the reference plane 30, that is a second port P2, is shown. The inner circuit still has a first port P1, a third port P3 and a fourth port P4 above the reference plane 30. Beside the ordinary components in the circuit, the transmission line effect is under consideration. Such as a first transmission line module 601 and a second transmission line module 602 are appended to the unit cell for connecting to the line between the inner circuit and the outer circuit. Further, not only the transmission line itself affects the circuit, but also the coupling effect between the first transmission line 601 and the second transmission line 602 affects the circuit. For example, the un-matching impedance or the effect between the two transmission lines forms the mentioned dielectric loss.

Next, FIG. 6B has no the external communication port disposed, but the fifth port P5, the sixth port P6 and the seventh port P7 are disposed in the inner circuit for connecting with the subsystems. Similarly in the circuit, the effect between the first transmission line module 601 and the second transmission line module 602 is under consideration.

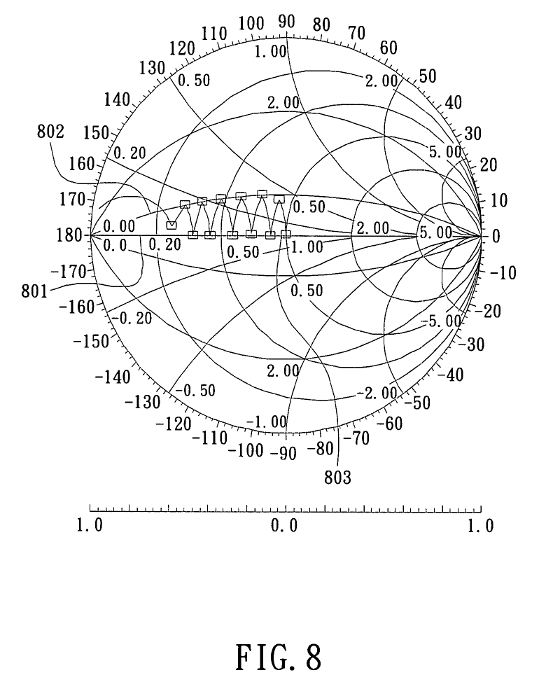

Furthermore, FIG. 7A and FIG. 7B show the curves presenting the relation between the insertion loss and frequency in consideration of the transmission line effect. In this exemplary embodiment, the default loss set for the transmission line effect is −3 dB.

FIG. 7A shows a curve representing the insertion loss between two subsystems of the embodiment shown in FIG. 6A. In which, point 1 and point 2 presenting the loss around frequency 2.45 GHz. In this embodiment, the curve S₁₂ indicates the behavior of the signals transmitted from the second port P2 disposed outside the circuit and received by the first port P1 disposed inside the module. Regarding the peak at point 1 that has only loss value −0.80 dB, which means this outside communication port, that is the feeding point, is suitable for the communication module. The curve S₃₄ indicates the behavior of the signals transmitted from the fourth port P4 and received by the third port P3. Since the ports P3 and P4 are used to connect to the inner circuit, the loss therefor is close to the insertion loss in consideration of the transmission line effect, such as the loss value −3.01 dB shown in point 2 at frequency 2.50 GHz.

On the other hand, FIG. 7B shows the curves representing the insertion loss for each communication port of the embodiment shown in FIG. 6B. In this embodiment, the curve S₇₆ indicates the behavior of the insertion loss for the subsystem interconnected between the sixth port P6 and the seventh port P7. The signals are transmitted from the sixth port P6 and received by the seventh port P7. Since the subsystem is in the inner circuit, the insertion loss is similar with the default loss value −3 dB in consideration of the transmission line effect. In which, there is no many variances at each frequency, such as the point 1 presenting loss value −3.01 dB at frequency 2.50 GHz. The curve S₇₅ indicates the behavior of the signals transmitted from the fifth port P5 and received by the seventh port P7. FIG. 6B shows that more interferences occurred between the ports P5 and P7. The point 2 indicates loss value −3.30 dB at frequency 2.50 GHz. However, a high insertion loss, where a loss value −17 dB is produced around the frequency 5 GHz, occurs at higher frequency in consideration of the transmission line effect. Otherwise, a fine behavior of insertion loss happens around frequency 2.5 GHz.

According to the experimental result shown in FIG. 7A and FIG. 7B as considering the transmission line effect, the second port P2 shown in FIG. 6 forms a feeding point of the embodiment. Accordingly, a lower insertion loss (0.8 dB in this embodiment) achieves through this feeding point without any change of the inner circuit of the module even. Further, a resonance effect can be used to achieve the like filtering. Nevertheless, if the approach is merely used for a dual subsystem embodied in FIG. 6B, the above-mentioned property has no many variances, such as the embodiment shown in FIG. 7B. Therefore, the external selective matching circuit provided by the signal matching module for the single or multiple systems of the present invention can reduce the insertion loss effectively and present the interference caused by the inner circuit. Similarly, the interference occurred among the subsystems can be reduced if the invention is applied to the multiple subsystems.

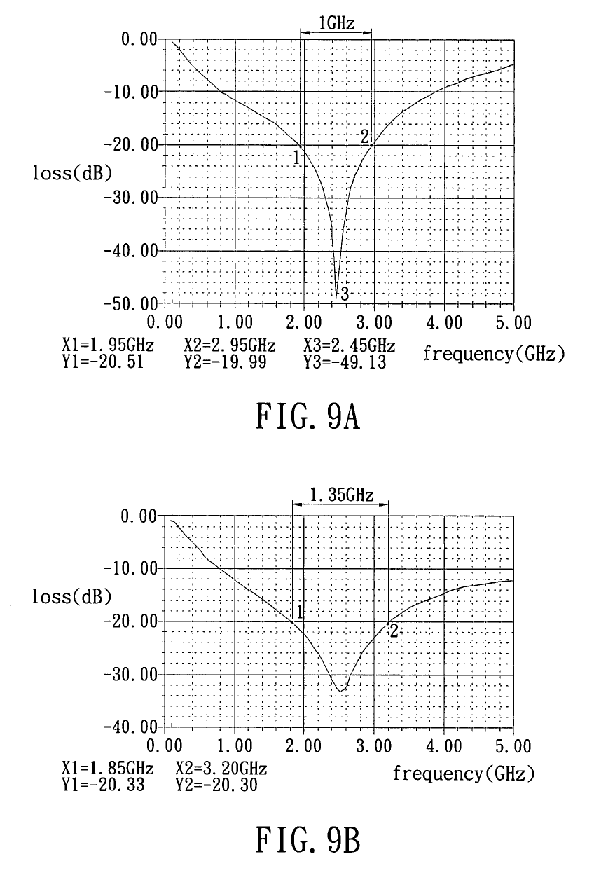

Reference is made to the Smith Chart shown in FIG. 8. The mentioned external selective matching circuit is further used to perform a multi-order matching, so as to reach a required quality factor (Q-value) and to tune the bandwidth.

FIG. 8 shows a sawtooth-shaped track of the impedance, that combines the result of the multi-order matching generated by the plurality of unit cells. The track shifts in a range of 0.5 of the Q-value, that is to tune the value back and forth around the curve 801 indicating 0 and the curve 802 indicating 0.5. For example, one time back-and-forth tuning means it uses the unit cell shown in FIG. 3 to tune the impedance matching in the circuit. The plurality of unit cells are used to tune to the required impedance and bandwidth one order by one order. In this exemplary embodiment, the object is to reach the middle point 803 by means of the plurality of unit cells.

According to the S-parameter shown in the mentioned Smith Chart and the curve presenting the insertion loss, the Q-value can be controlled under value 0.5 by means the multi-order matching circuit. In the meantime, the reflective value, that is the insertion loss, can be controlled at −20 dB, and the bandwidth can reach 1.9 GHz.

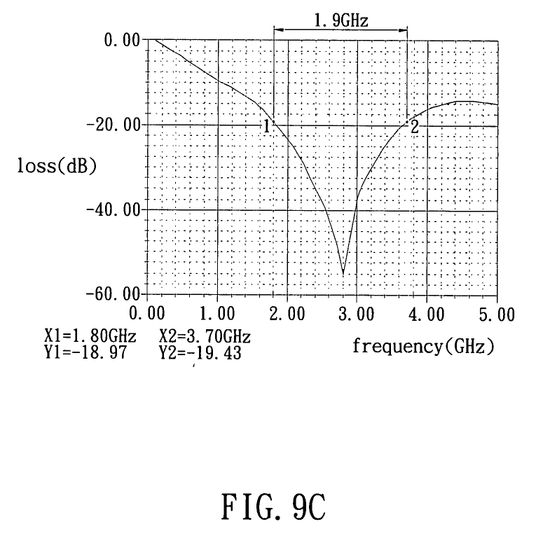

Reference is made to FIG. 9A, that shows a curve presenting the relation of bandwidth and insertion loss of a conventional art that uses a general matching circuit. In which, the insertion loss is controlled to −20 dB and its bandwidth is about 1 GHz. In contradistinction, FIG. 9B shows an embodiment with the insertion loss being controlled to around −20 dB, the Q-value being smaller than 0.5, and the bandwidth being around 1.35 GHz by utilizing a matching circuit formed by a unit cell. Further, FIG. 9C utilizes the mentioned multi-order matching circuit to control the Q-value being under 0.5, the insertion loss being around −20 dB, and the bandwidth being around 1.9 GHz.

Based on the experiment, the signal matching module of the present invention can flexibly tune the impedance matching of the entire communication module so as to reach the required matching. Obviously, the performance of the bandwidth provided by the signal matching module of the present invention is better than the bandwidth provided by the conventional art. More, the multi-order matching circuit is more effective.

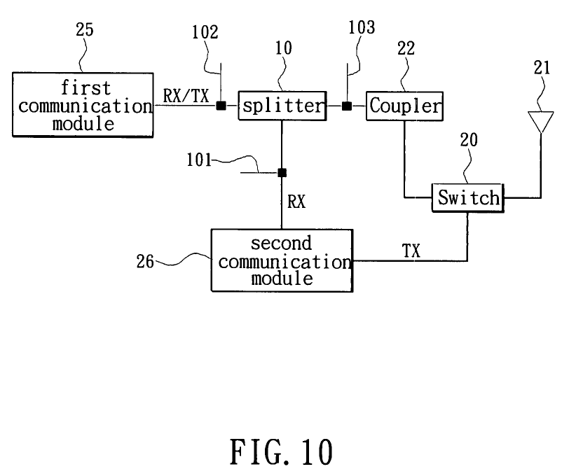

The preferred embodiment of the signal matching module of the present invention is shown in FIG. 10. A circuit having multiple wireless communication subsystems, including a first communication module 25 and a second communication module 26, is provided. A switch 20 is used to switch the communication signals among the systems. The first communication module 25 is used to operate reception and transmission (RX/TX) via a duplex transmission line. The communication module 26 uses a transmission line with reception (RX) and another transmission line with transmission (TX). These two communication modules utilizes a coupler 22 to couple with the RX/TX transmission line of the first communication module 25 and the transmission line with reception of the second communication module 26. A splitter 10 is used to discriminate the signals, and further to dispatch the transmission direction. After that, the signals are switched and coupled to an antenna 21 for transmitting or receiving. In the embodiment, the signal matching module is used to connect with the transmission line coupling with each electronic component, such as a first matching module 101 disposed on the transmission line between the splitter 10 and the second communication module 26, and a second matching module 102 between the splitter 10 and the first communication module 25, and a third matching module 103 between the splitter 10 and the coupler 22. In the preferred embodiment of the present invention, the mentioned first communication module 25 can be, but not limited to, a Bluetooth module that features the duplex transmission line. The second communication module 26 can be, but not limited to, a WiFi module that has two separate transmission line.

To sum up, the signal matching module for the single or multiple systems of the present invention can enhance the flexibility in use of a communication module, and performance for each subsystem. The selective matching circuit provided by the present invention can offer a tuning function to required matching if in need. If the inner circuit can be tuned to required matching, the multi-order matching circuit can further reach the require Q-value, and tune the bandwidth. More, a resonance effect can achieve the like filtering for helping the development of future design of the module.

While the invention has been described by means of a specification with accompanying drawings of specific embodiments, numerous modifications and variations could be made thereto by those skilled in the art without departing from the scope and spirit of the invention set forth in the claims.

What is claimed is:

1. A signal matching module for single or multiple systems,
comprising:
a unit cell connected with single or multiple subsystems, the unit cell having a plurality of interconnected electronic components or transmission lines;
one or more communication ports inside the signal matching module, electrically connected with the unit cell for connecting to various signaling sources;
one or more communication ports outside the signal matching module, connected with the unit cell, and serving as external feeding points of the signal matching module;
wherein the signal matching module connects with the external signaling sources through the communication ports, and a tuning interface is provided for an inner circuit of the signal matching module.

2. The signal matching module of the claim 1, wherein the unit cell includes one or more passive components.

3. The signal matching module of the claim 1, further comprising a plurality of terminals for connecting to other communication ports, circuits, modules or ground ends.

4. The signal matching module of claim 1, wherein a multi-order matching circuit is formed by combining the plurality of unit cells, thereby tuning to a required quality factor and bandwidth.

5. The signal matching module of claim 1, wherein the signal matching module is applied to a communication system.

6. The signal matching module of claim 5, wherein the signal matching module connects to the transmission lines of the electronic components of the communication systems.

7. The signal matching module of claim 5, wherein the communication system can be one of the following, WiFi, Bluetooth, GSM, UWB, DVB, GPS, 3G and WiMAX.

8. The signal matching module of claim 1, wherein the external communication port electrically connects to a selective matching circuit, whereby the selective matching circuit is used to operate testing and tuning externally when the inner matching component of the signal matching module fails to reach a required matching.

9. A signal matching module for single or multiple systems,
comprising:
a unit cell connecting to single or multiple subsystem, including a plurality of interconnected electronic components or transmission lines;
one or more inner or outer communication ports for the subsystems, which electrically connect to the unit cell for connecting with various signaling sources;
a selective matching circuit externally connected with the signal matching module for the systems, which is used to operate testing and tuning externally when an inner component of the signal matching module fails to reach a required matching, so that no extra loading will be received by the inner circuit of the signal matching module and further the direct interference or signal loss is avoided.

10. The signal matching module of claim 9, wherein the unit cell includes one or more passive components.

11. The signal matching module of claim 9, wherein the signal matching module further comprises a plurality of connecting terminals for connecting with other communication ports, circuits, modules or ground ends.

12. The signal matching module of claim 9, wherein a multi-order matching circuit is formed by combining the plurality of unit cells, thereby tuning to a required quality factor and bandwidth.

13. The signal matching module of claim 9, wherein the signal matching module is applied to a communication system.

14. The signal matching module of claim 13, wherein the signal matching module connects to a transmission line of each electronic component of the communication system.

15. The signal matching module of claim 13, wherein the communication system is implemented as one of the following wireless communication systems, such as WiFi, Bluetooth, GSM, UWB, DVB, GPS, 3G and WiMAX.
